(19) United States
(12) Patent Application Publication
(10) Pub. No.: US 2015/0340020 A1
(43) Pub. Date: Nov. 26, 2015

(54) Detachable Utility Support

(71) Applicant: Gabriel Joseph Noska, Spring City, PA (US)

(72) Inventor: Gabriel Joseph Noska, Spring City, PA (US)

(21) Appl. No.: 14/720,607

(22) Filed: May 22, 2015

Related U.S. Application Data
(60) Provisional application No. 61/997,126, filed on May 23, 2014.

(51) Int. Cl. G10G 5/00

(52) U.S. Cl. CPC G10G 5/00

(57) ABSTRACT

A detachable utility support for a guitar and its accessories has a connector having an angled slot and a generally parallel slot, a stabilizer, and a utility support accessory having a first end and a flared second end. Stringed musical instrument accessories are integrated with the utility support accessory either by being built in or using a variety of fasteners or fastening materials. The connector and the stabilizer are fastened to the instrument. The first end of the utility support accessory is detachably inserted into either the angled slot of the connector in a downwardly and outwardly stringed musical instrument supporting position or the generally parallel slot of the connector in an adjacent and generally parallel to the stringed musical instrument storage position.

### RELATED APPLICATIONS

The present application is based on, and claims priority from U.S. Provisional Application Ser. No. 61/997,126, filed May 23, 2014, the disclosure of which is hereby incorporated by reference herein in its entirety.

### BACKGROUND OF THE INVENTION

To properly play and maintain a stringed musical instrument such as a guitar a variety of accessories and tools are required. It is advantageous to the person using the stringed musical instrument to have these accessories readily available, organized and preferably nearby. Some of these tools and accessories include a stand, a tuner, a capo, picks, a harmonica and a string winder.

### FIELD OF THE INVENTION

The invention relates generally to the field of musical instrument accessories and more specifically to combination musical instrument accessories.

### DESCRIPTION OF RELATED ART

U.S. Pat. No. 6,747,197 B2 to Kellogg discloses a stringed instrument stand that attaches directly to the body of the instrument by means of the screw attaches to the instrument body that normally holds one end of a strap. This stand folds flat when the user is playing the instrument or when the instrument is stored and folds out when used as a stand.

U.S. Pat. No. 7,968,778 B2 to D'Addario discloses a combination of a capo with attached tuner having a sensor that picks up vibrations through the capo. The capo and tuner combination is attachable to the neck of the guitar like a conventional capo, but provides the advantage of continuously being able to view the tuner while tuning at any given capo position while pausing between playing the guitar.

U.S. Pat. No. 2007/0143929 to Selin is directed to a combination device that includes a capo for a stringed musical instrument such as a guitar or a banjo, and a beverage bottle and/or can opener integrally coupled to the capo. In various aspects of the embodiment, the container opener is an integral part of different portions of the capo.

The prior art above teaches a stringed instrument stand that attaches directly to the body of the instrument by means of the screw attaches to the instrument body that normally holds one end of a strap, a capo with tuner and a combination capo-container opener device but does not teach a support for a stringed musical instrument that is detachable so that it may serve several functions by integrating other accessories with the support itself. The prior art does not teach a support for a stringed musical instrument that requires no tools to attach itself to the instrument. The prior art does not teach a support or stand for a stringed musical instrument in which accessories are fastened to, attached to or integrated with. Aspects of the present invention fulfill these needs and provide further related advantages as described in the following summary.

### SUMMARY OF THE INVENTION

In accordance with a preferred embodiment of the invention, there is disclosed a detachable utility support for a stringed musical instrument and its accessories comprising: a connector having an angled slot and a generally parallel slot, a stabilizer and a utility support accessory having a first end, a flared second end and at least one way in which accessories are fastened to, attached to or integrated with the utility support accessory. Ways in which accessories are fastened to, attached to or integrated with the utility support accessory include any one of the following or any combination thereof: hook-and-loop fastening material, rubber bands, screws and restickable strips. The first end of the utility support accessory is detachably inserted into the angled slot of the connector in a downwardly and outwardly stringed musical instrument supporting position but it can also be removed from that slot and then detachably inserted into the generally parallel slot of the connector in an adjacent and generally parallel to the stringed musical instrument storage position. The connector is fastened to the back of the stringed musical instrument with adhesive tape. The stabilizer is fastened along the bottom rear edge of the stringed musical instrument with adhesive tape.

In accordance with an alternative embodiment of the invention, there is disclosed a detachable utility support for a stringed musical instrument and its accessories comprising: a back piece having a lower stabilizing portion and an upper connecting portion, a plurality of hooked elastic tie downs and a utility support accessory. The back piece has a plurality of apertures disposed around its edges. The upper connecting portion of the back piece has an angled slot and a parallel slot. The utility support accessory has a first end, a flared second end and at least one way in which accessories are fastened to, attached to or integrated with the utility support accessory. Ways in which accessories are fastened to, attached to or integrated with the utility support accessory include any one of the following or any combination thereof: hook-and-loop fastening material, rubber bands, screws and restickable strips. The first end of the utility support accessory is detachably inserted into the angled slot of the connector in a downwardly and outwardly stringed musical instrument supporting position but it can also be removed from that slot and then detachably inserted into the generally parallel slot of the connector in an adjacent and generally parallel to the stringed musical instrument storage position. The plurality of apertures disposed around the edges of the back piece link to the sound hole of the stringed musical instrument with the plurality of hooked elastic tie downs. The hooked elastic tie downs comprise: an elongated elastic member having a pair of opposite ends; each of said ends of the elongated elastic member having a hook coupled thereto.

The lower stabilizing portion of the back piece can further comprise a generally flat area with an elongated hole. The generally flat area with an elongated hole is disposed between the stringed musical instrument and the strap pin of the stringed musical instrument such that the back piece is fastened to the stringed musical instrument. This alternative embodiment of the invention can utilize either or both means of fastening the back piece to the stringed musical instrument: linking the back piece to the sound hole with the hooked elastic tie downs; disposing the generally flat area with an elongated hole between the stringed musical instrument and the strap pin; or both methods in combination with each other.

Any of the above mentioned embodiments may utilize a variation to the utility support accessory wherein the utility support accessory further comprises: a mechanically integrated tuner, a capo jaw having a rubber string engaging pad or strip, a graspable arm, a pivot and a torsion spring. The pivot couples the capo jaw to the utility support accessory whereby the capo jaw and the utility support accessory are rotatably movable with respect to each other between a neck clamping closed position and an open position. The graspable arm is connected to the capo jaw whereby a squeezing action applied thereto will cause the capo jaw and the utility support accessory to move from the neck-clamping closed position toward the open position. The torsion spring is coupled directly or indirectly to the capo jaw and the utility support accessory such that it exerts a closing force that acts on the capo jaw and the utility support accessory. This variation does not prohibit the utility support accessory from using the at least one fastening means as mentioned in the original embodiments. For example, the capo and tuner are mechanically integrated with the utility support accessory while other accessories, such as a harmonica and a pick, utilize the fastening means such as the hook-and-loop fastening material.

A primary objective of the invention is to provide advantages not claimed in prior art.

Another object of the invention is to provide a support for a stringed musical instrument which is easily attached to and detached from a stringed musical instrument.

A further object of the invention is to provide an accessory for a stringed musical instrument which allows many of the accessories, tools and devices needed to play and maintain the stringed musical instrument to be readily available, organized and near the instrument.

Yet another object of the invention is to provide a stand or support for a stringed musical instrument that other accessories needed to play and maintain the stringed musical instrument may attach to or integrate with.

Other features and advantages of aspects of the present invention will become apparent from the following more detailed description, taken in conjunction with the accompanying drawings, which illustrate, by way of example, the principles of aspects of the invention.

### BRIEF DESCRIPTION OF THE DRAWINGS

The accompanying drawings illustrate aspects of the present invention. In such drawings:

FIG. 1 is a perspective view of the utility support accessory;

FIG. 2 is a perspective view of the connector;

FIG. 3 is a perspective view of the front of the stabilizer;

FIG. 4 is a perspective view of the first end of the utility support accessory inserted in the angled slot of the connector;

FIG. 5 is a perspective view of the first end of the utility support accessory inserted in the generally parallel slot of the connector;

FIG. 6 is a perspective assembly view of the connector and stabilizer in relation to the stringed musical instrument;

FIG. 7 is a side view of a variation for the utility support accessory;

FIG. 8 is a front side view of the utility support accessory with built-in capo parts attached to the neck of a stringed musical instrument;

FIG. 9 is a perspective view of an alternative embodiment of the invention;

FIG. 10 is a left side view of an alternative embodiment illustrating the hooked elastic tie downs in relation to the stringed musical instrument;

FIG. 11 is a right side view of an alternative embodiment illustrating the hooked elastic tie downs in relation to the stringed musical instrument;

FIG. 12 is a front side view illustrating the hooked elastic tie downs linking with the sound hole and also shows the hooked elastic tie downs in relation to the spacer;

FIG. 13 is a top side view of the spacer;

FIG. 14 is a front side view illustrating the hooked elastic tie downs linking with the connecting link;

FIG. 15 is a perspective view of the utility support accessory in relation to the generally parallel slot of the upper connecting portion;

FIG. 16 is a perspective view of the utility support accessory in relation to the angled slot of the upper connecting portion;

FIG. 17 is a perspective view of a variation of the lower stabilizing portion of the back piece; and

FIG. 18 is a perspective view of the variation of the lower stabilizing portion in relation to the stringed musical instrument and its strap pin.

### DETAILED DESCRIPTION OF THE INVENTION

The above described drawing figures illustrate aspects of the invention, which are further defined in the following description.

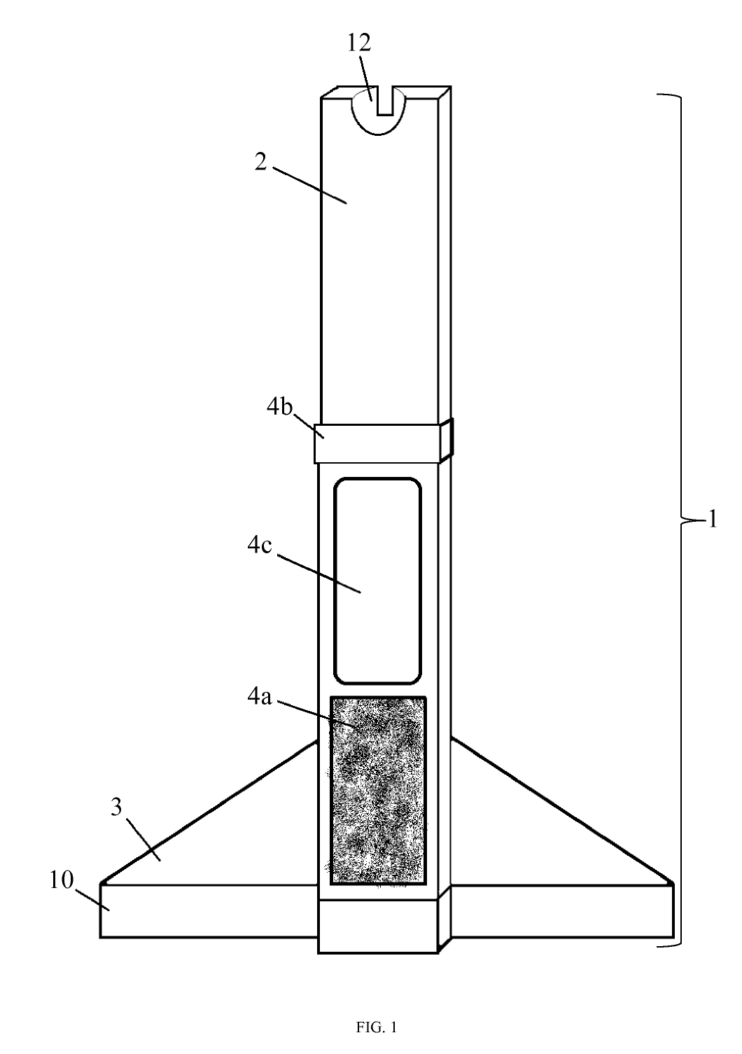

Referring to FIG. 1, there is shown a perspective view of the utility support accessory 1 which has a first end 2, a flared second end 3 and at least one fastening means 4. Ways in which accessories for the stringed musical instrument may be fastened to the utility support accessory 1 include hook-and-loop fastening material 4a, rubber bands 4b, and restickable strips 4c. The utility support accessory 1 can possess other features including a rubber grip 10 disposed around its flared second end 3 and a notch 12 with a size and thickness so that it is capable of fitting under and pulling out a peg that secures the instruments strings. The utility support accessory 1 can be made from a variety of materials such as plastic, wood or even metal. If wood is being used to make the utility support accessory 1 one would take an elongated strip of wood and fasten a flared piece to the bottom of the strip. This way, the utility support accessory 1 has a wide bottom suitable for supporting the instrument it is being attached to and a first end 2 which is capable of being inserted into its respective slot of the connector. Plastic may be used in the same fashion but ideally would be used via a 3d printer or injection molding. Lastly, if metal is being used, preferably a light weight metal such as aluminum, it can be assembled in the same fashion the wood is or the two pieces may be cast or welded together. Any of the above mentioned materials are suitable and any of the above mentioned materials may have their pieces fastened together using a multitude of fasteners or an adhesive which works well with its respective material. In the above mentioned embodiments, a 3d printer or a mold is ideal for making this component as well as for the other components that make up the present invention.

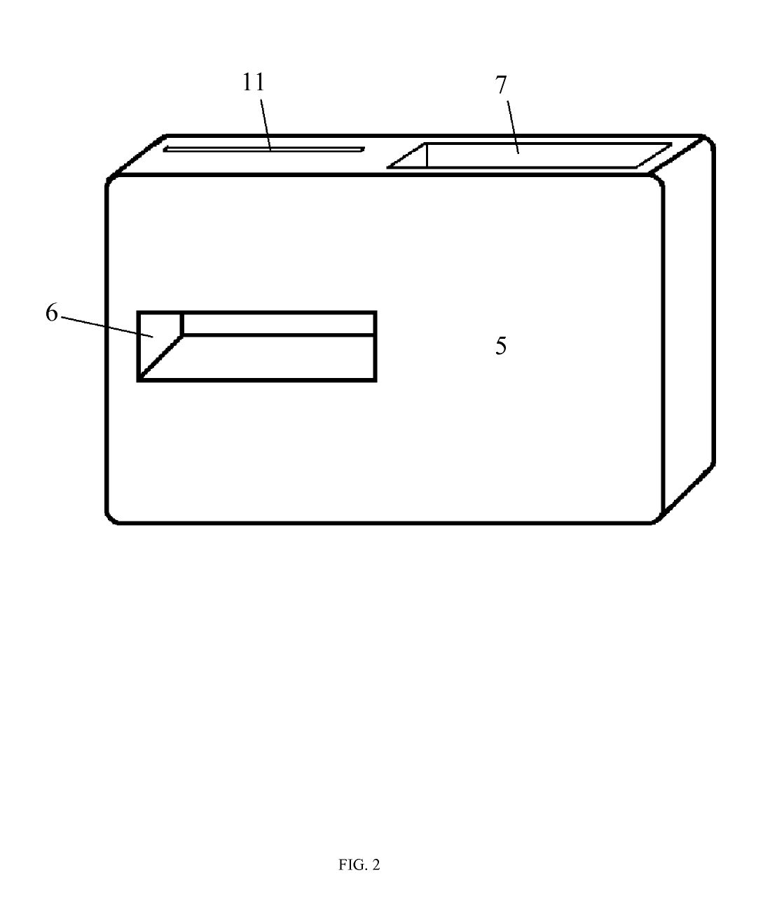

FIG. 2 shows a perspective view of the connector 5, wherein the connector has multiple slots, each having its own unique purpose. The angled slot 6 is a slot that is angled downwardly and outwardly from the instrument that the connector 5 is fastened to at approximately forty five degrees. The generally parallel slot 7 is a slot within the connector 5 that runs approximately or generally parallel to the instrument that the connector 5 is fastened to. A third slot 11 may be built in to the connector 5 which is used to receive at least one pick. The connector 5 may also be made out of wood, plastic or metal. Ideally it would be made using a mold or a 3d printer. It is a solid piece wherein the slots are hollowed out of it to receive its respective piece.

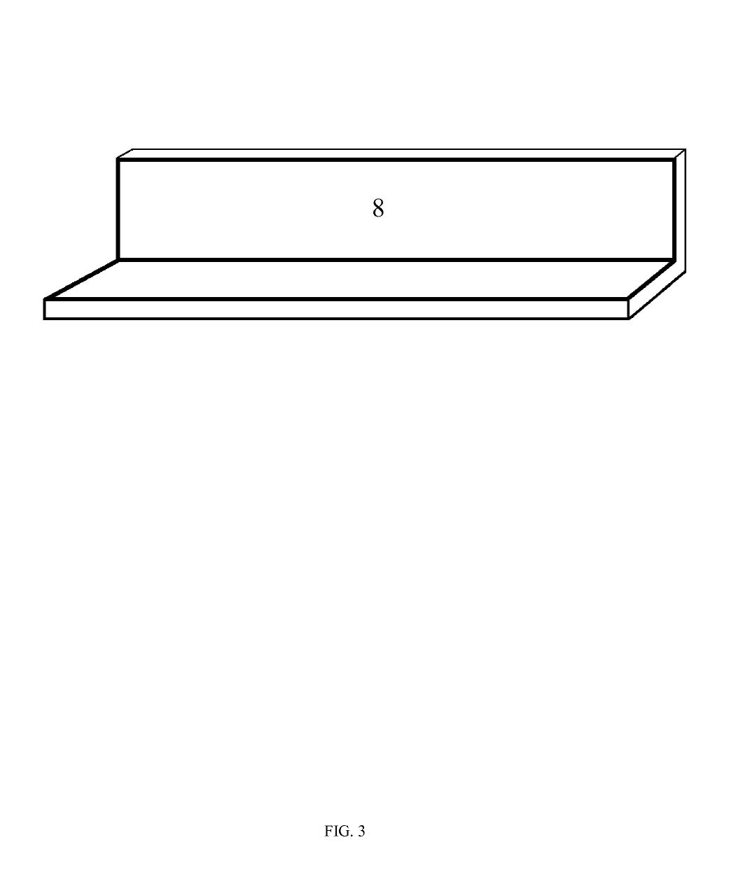

FIG. 3 is a perspective view of the front of the stabilizer 8. The stabilizer 8 is an L shaped piece that provides a flat surface for the instrument it is fastened to. Most stringed musical instruments have round bottoms, so the stabilizer 8 is a flat surface that fastens to the bottom of the instrument to keep the instrument steady or stable so that it won't tip over as easily. Just like the other components mentioned above, the stabilizer 8 may be made from the same materials. It isn't critical that the piece be L shaped, it need only provide a flat surface for the instrument to rest on. In the above embodiments the stabilizer 8 is illustrated as an L shaped piece but it may also just be a flat rectangular piece that fastens directly to the bottom rear edge of the instrument.

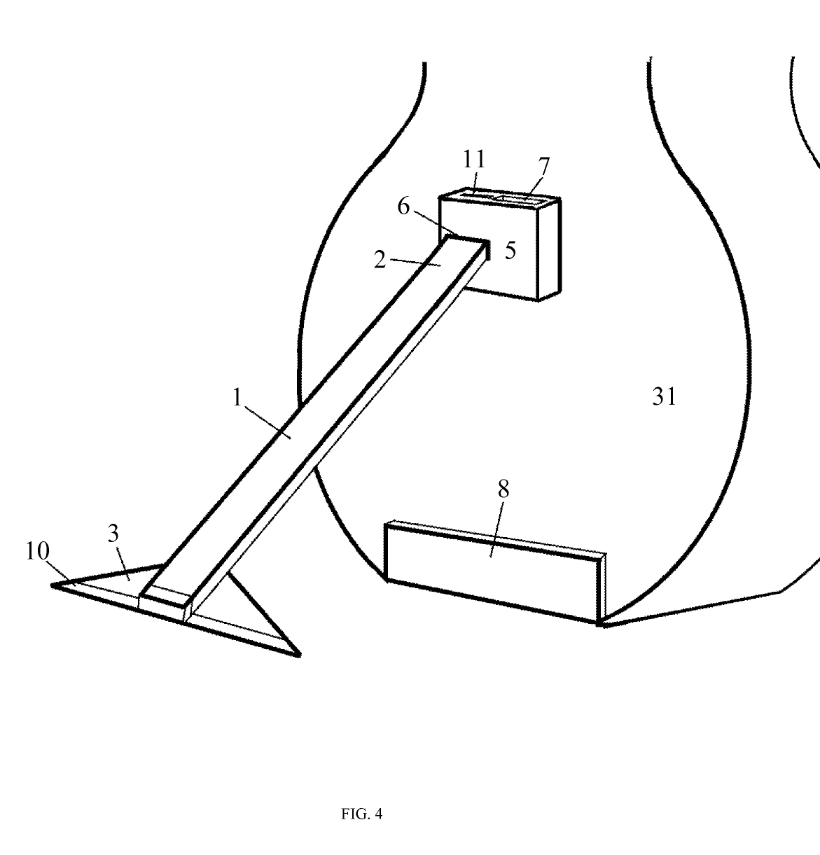

FIG. 4 shows a perspective view of the utility support accessory 1 inserted in the angled slot 6 of the connector 5 in a downwardly and outwardly stringed musical instrument 31 supporting position. In this figure the connector 5 and stabilizer 8 are fastened to the stringed musical instrument 31 and the utility support accessory 1 is inserted in the angled slot 6 of the connector 5. This figure illustrates the angled slot 6 of the connector 5 and the first end 2 of the utility support accessory 1 being each other's male and female counterparts. While in this position the utility support accessory 1 descends downwardly and outwardly such that the flared second end 3 of the utility support accessory 1 engages the surface below the stringed musical instrument 31 thus supporting the stringed musical instrument 31 in an approximately upright position. A rubber grip 10 is disposed around the second flared end 3 of the utility support accessory 1 to further prevent the stringed musical instrument 31 from making unwanted movements. This figure also shows the generally parallel slot 7 and the third slot 11 of the connector 5 in relation to the other components of the invention.

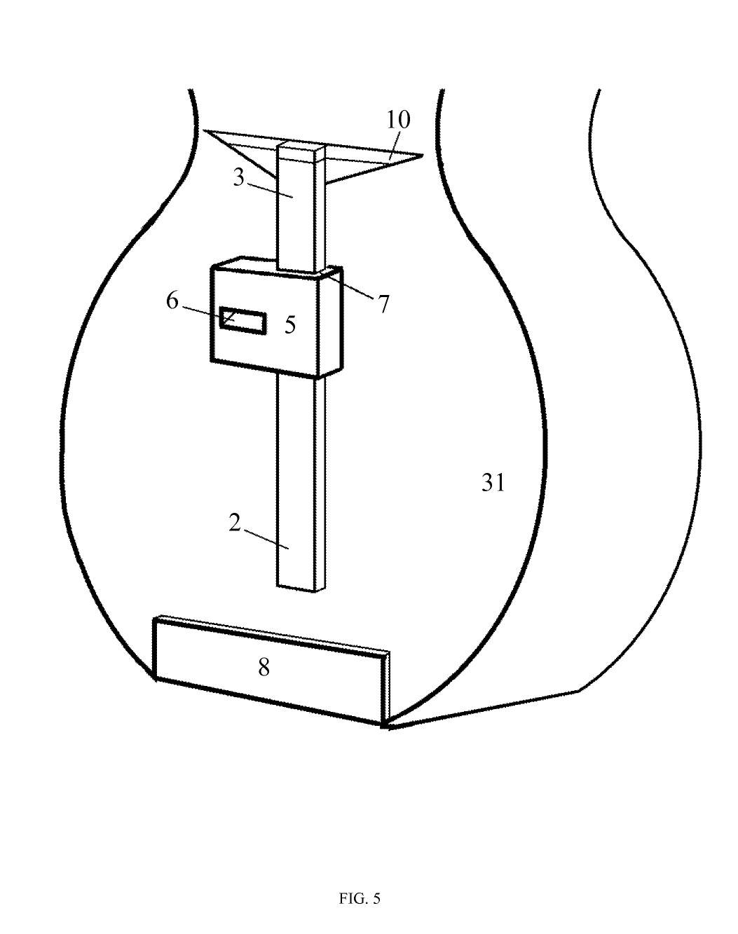

FIG. 5 shows a perspective view of the first end 2 of the utility support accessory 1 inserted in the generally parallel slot 7 of the connector 5 in an adjacent and generally parallel to the stringed musical instrument 31 storage position. The generally parallel slot 7 is a hollow channel-like aperture that runs vertically throughout the connector 5. The first end 2 of the utility support accessory 1 is the male counterpart that fits inside of the generally parallel slot 7 of the connector 5. This position is utilized when the utility support accessory 1 is no longer needed to support the stringed musical instrument 31 and is stored for later use. This figure also shows the connector 5 and the stabilizer 8 fastened to the stringed musical instrument 31.

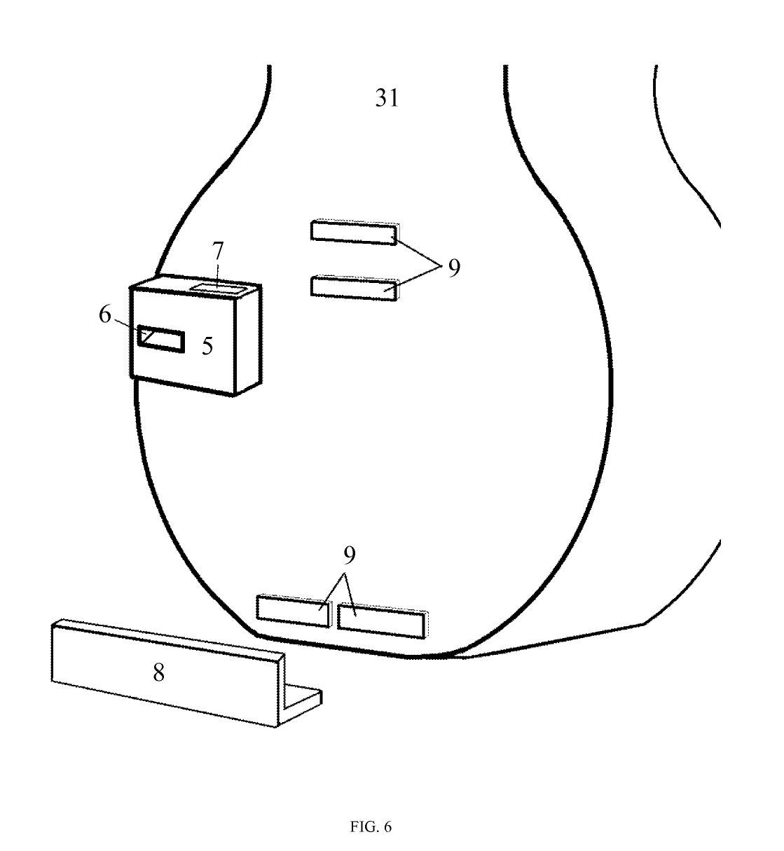

FIG. 6 shows a perspective assembly view of the connector 5 and the stabilizer 8 in relation to the stringed musical instrument 31. In this embodiment both pieces are fastened to the stringed musical instrument 31 using double-sided adhesive tape 9. A variety of adhesive tapes 9 may be used to fasten these pieces to the stringed musical instrument 31 including but not limited to double-sided adhesive tape, double-sided foam adhesive tape and stretch releasing adhesive tape articles.

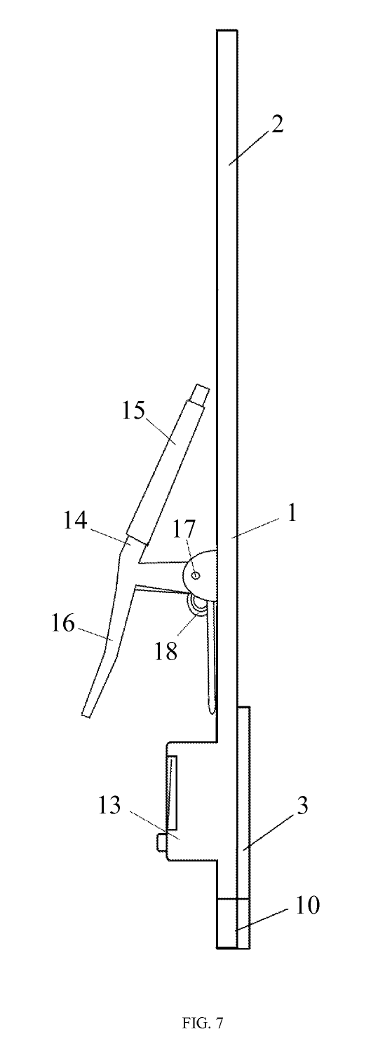

FIG. 7 shows a side view of a variation of the utility support accessory 1. Any embodiment of the invention may utilize this variation, or the method that uses the at least one fastening means 4 or it may use any combination thereof. An example to further explain this would be a utility support accessory 1 that comprises a capo jaw 14 mechanically integrated into the utility support accessory 1 while utilizing at least one fastening means 4 such as hook-and-loop fastening material 4a to fasten a tuner to the utility support accessory 1. In addition, a harmonica could be fastened to the same utility support accessory 1 using restickable strips 4c. This variation is not prohibitive in any way in respect to how accessories are fastened to the utility support accessory 1. In this variation, a pivot 17 couples the capo jaw 14 to the utility support accessory 1 whereby they are rotatably movable with respect to each other between a neck clamping closed position and an open position. The capo jaw 14 further comprises a rubber pad 15 disposed around its string engaging area. A graspable arm 16 is connected to the capo jaw 14 adding leverage to assist in opening the capo jaw 14 and the utility support accessory 1 from the neck clamping closed position toward the open position. A torsion spring 18 is coupled directly or indirectly to the capo jaw 14 and the utility support accessory 1 exerting a closing force that acts on the capo jaw 14 and the utility support accessory 1. Additionally, a mechanically integrated tuner 13 can be included in the utility support accessory 1. Using this variation, the utility support accessory 1 would ideally be manufactured from plastic. A mechanically integrated tuner 13 would be accomplished by integrating a tuner housing and a display means with the utility support accessory 1. The housing would house a microphone or other input means, a circuit, a computing means for computing a frequency, a memory in which specified frequencies are stored and a comparison means for comparing different frequencies.

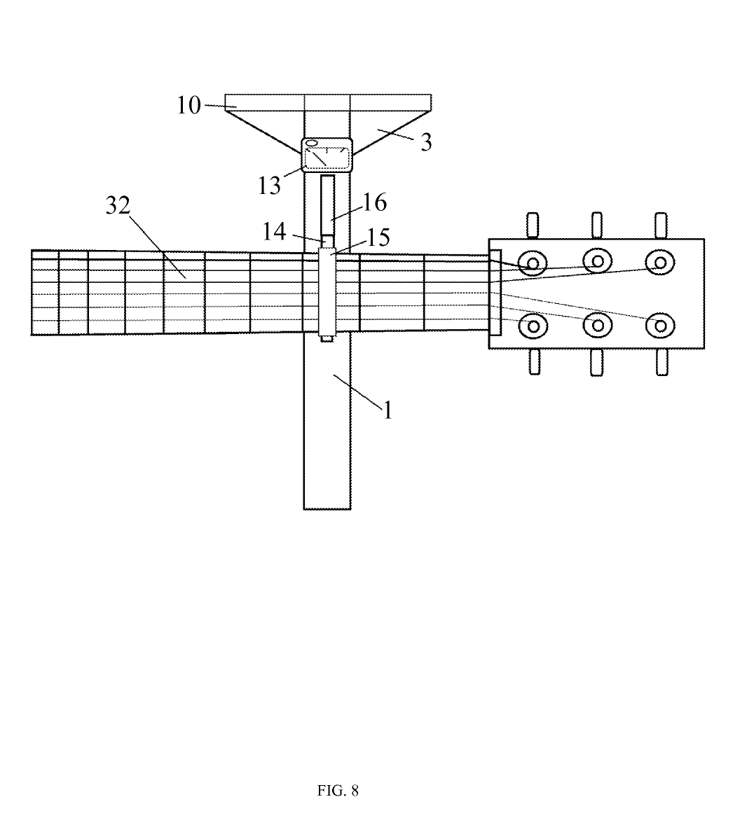

FIG. 8 is a front side view of the utility support accessory 1 with built-in capo parts attached to the neck 32 of a stringed musical instrument 31. This figure shows a mechanically integrated tuner 13 adjacent to the capo jaw 14 and not adjoined to it. This figure shows a support for a guitar with accessories such as a tuner 13 and a capo jaw 14 mechanically integrated with it. By making the utility support accessory 1 detachable, the user may remove it from the connector 5 and upper connecting portion 23 to utilize accessories that are fastened to it or integrated with it.

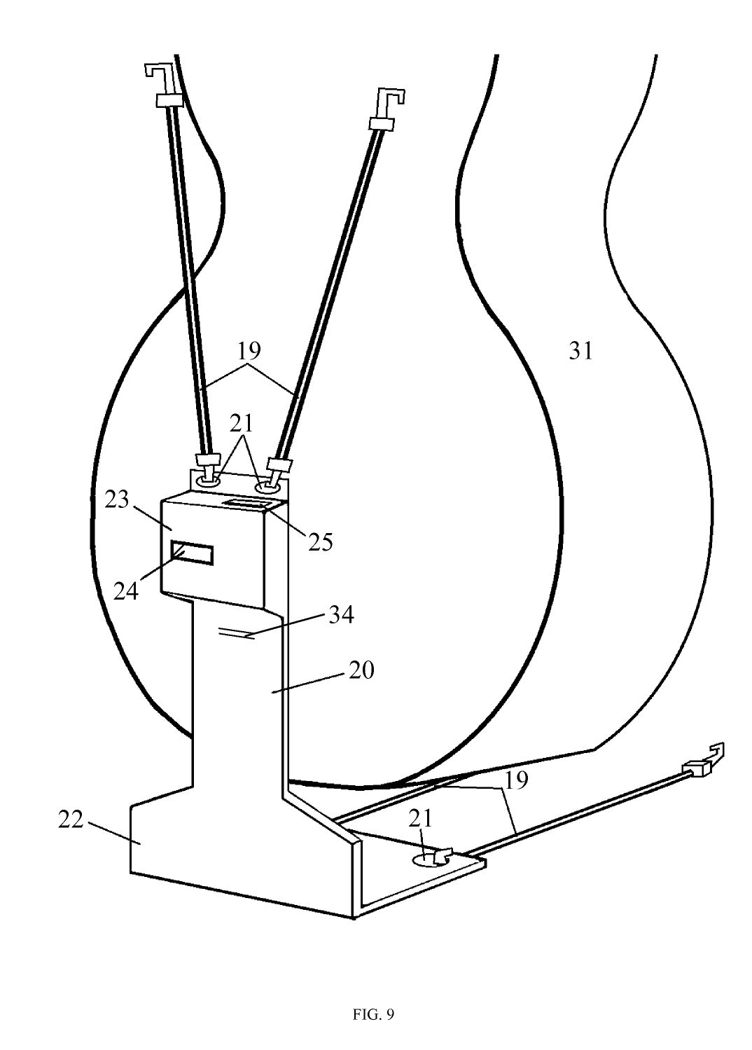

FIG. 9 shows a perspective view of an alternative embodiment of the invention. In this alternative embodiment, the connector 5 and stabilizer 8 are integrated into one back piece 20. This back piece 20 comprises a lower stabilizing portion 22 and an upper connecting portion 23. The upper connecting portion 23 has an angled slot 24 and a generally parallel slot 25. In essence, these are the same components as in the other embodiment listed in this disclosure. The back piece 20 also comprises a plurality of apertures 21 around its edges, primarily around the edges near to the upper connecting portion 23 and the lower stabilizing portion 22. The plurality of apertures 21 link to the plurality of hooked elastic tie downs 19 which link to the sound hole 33 of the stringed musical instrument 31. The main reason for this “tie down” embodiment is to limit having things, such as tape, come into contact with the stringed musical instrument 31.

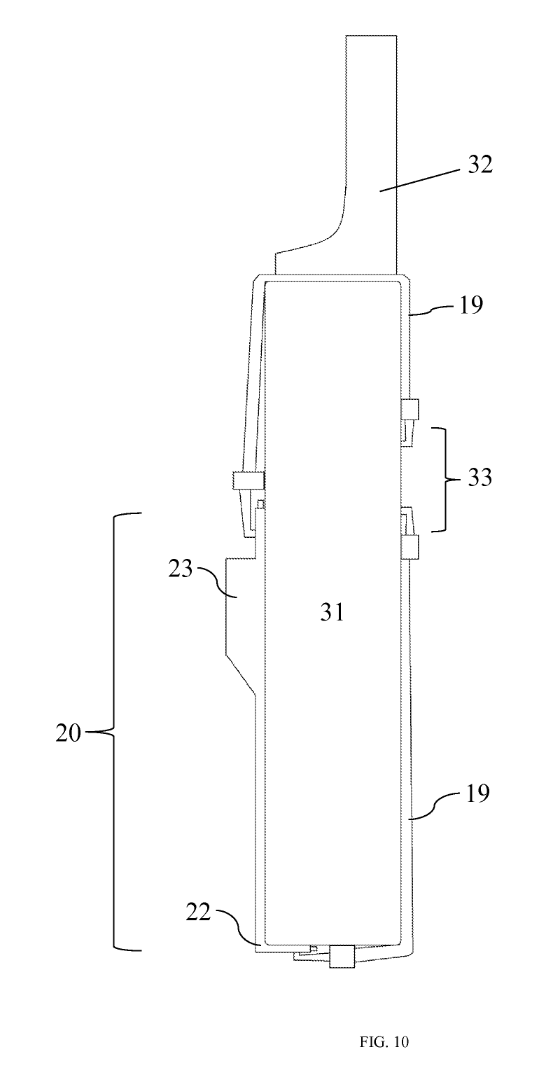

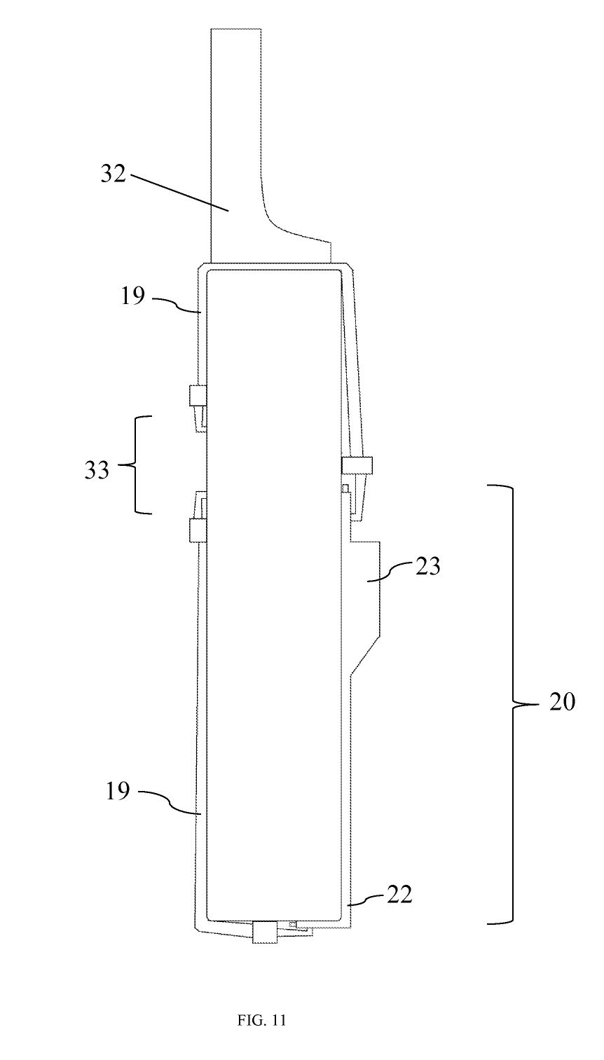

FIGS. 10 and 11 show side views of an alternative embodiment illustrating how the plurality of apertures 21 link to their respective plurality of hooked elastic tie downs 19, then each of the plurality of hooked elastic tie downs 19 wrap around their respective part of the stringed musical instrument 31 and link to the sound hole 33 of the stringed musical instrument 31. The plurality of hooked elastic tie downs 19 that link the plurality of apertures 21 near the upper connecting portion 23 to the sound hole 33 wrap around the top of the stringed musical instrument 31. The plurality of hooked elastic tie downs 19 that link the plurality of apertures 21 near the lower stabilizing portion 22 to the sound hole 33 wrap around the bottom of the stringed musical instrument 31.

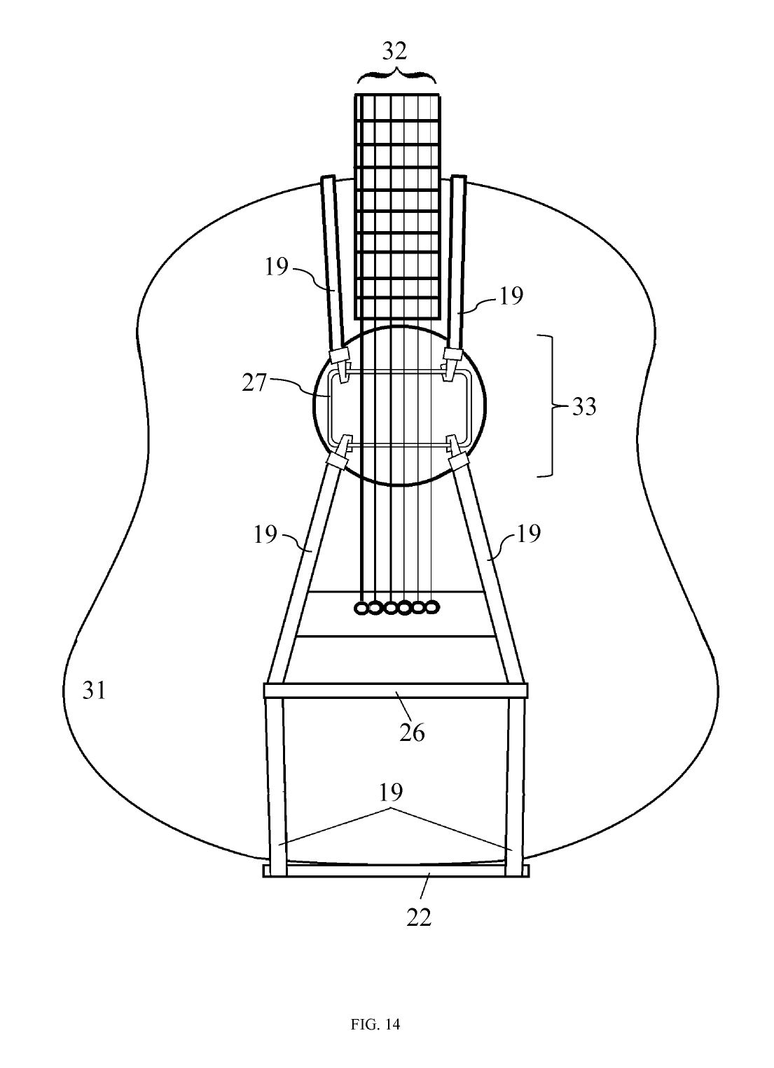

FIG. 14 is a front side view illustrating that this embodiment may further comprise a connecting link 27 which is disposed in or around the sound hole 33 of the stringed musical instrument 31 wherein the plurality of hooked elastic tie downs 19 link to the connecting link 27 instead of the sound hole 33. The purpose of the connecting link 27 is to accommodate people who might fear or dislike linking the plurality of hooked elastic tie downs 19 to the sound hole 33 of the stringed musical instrument 31. This fear is dependent upon the user's tolerance to things coming into contact with their stringed musical instrument 31. Most people will not need such an accommodation but for those who do need it, it will likely be considered essential.

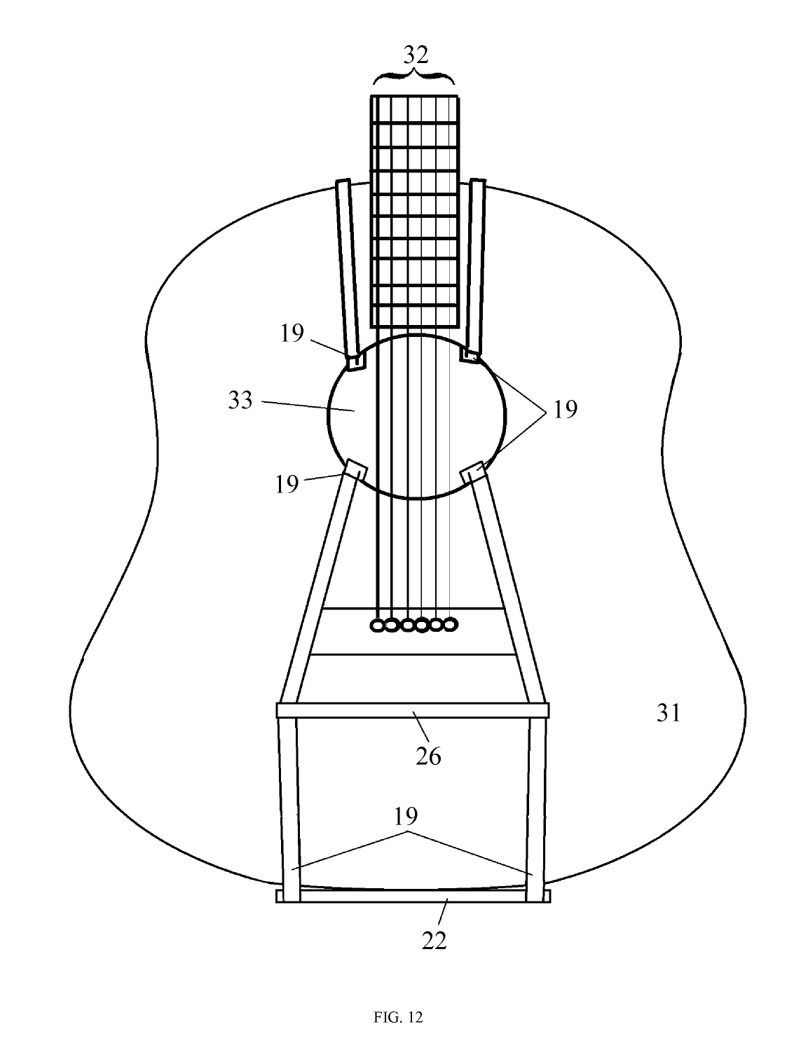

FIG. 12 is a front side view illustrating that this embodiment may further comprise at least one spacer 26 wherein the at least one spacer 26 is disposed between at least two of the plurality of hooked elastic tie downs 19 such that the spacer 26 has an influence on the course of the plurality of hooked elastic tie downs 19.

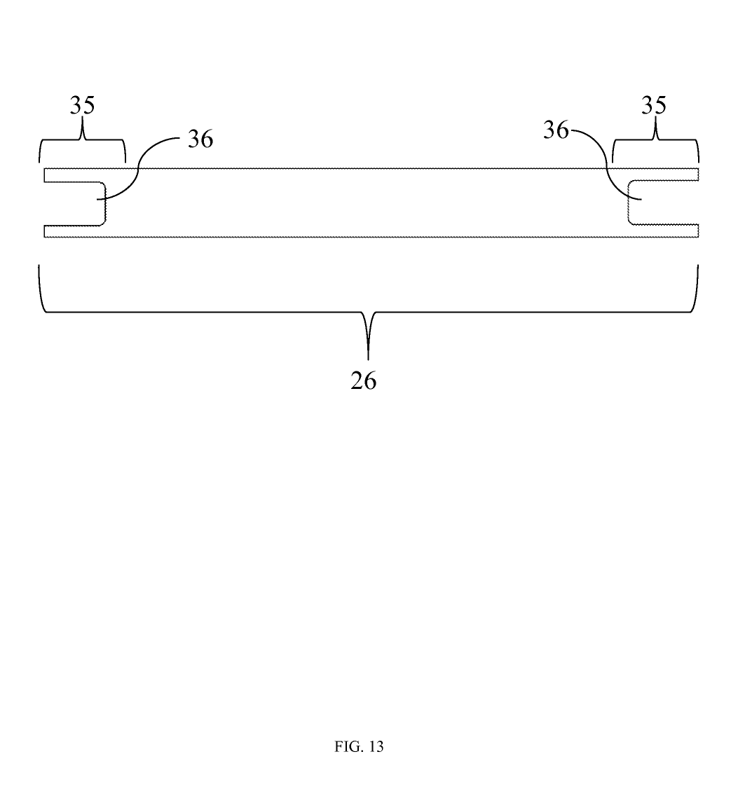

FIG. 13 is a top or bottom side view illustrating that the spacer 26 is a rod like piece having a pair of opposite ends. Each opposite end has a groove or channel where a hooked elastic tie down 19 is disposed. By going through the spacer 26, the course of each hooked elastic tie down 19 is altered. The spacer 26 will prevent any of the hooked elastic tie downs 19 from interfering with the strings of the stringed musical instrument 31. The main difference between this embodiment and the other embodiment disclosed is the means of fastening the connector 5 and the stabilizer 8 to the stringed musical instrument 31. The utility support accessory 1 is the same no matter what embodiment it is being used with.

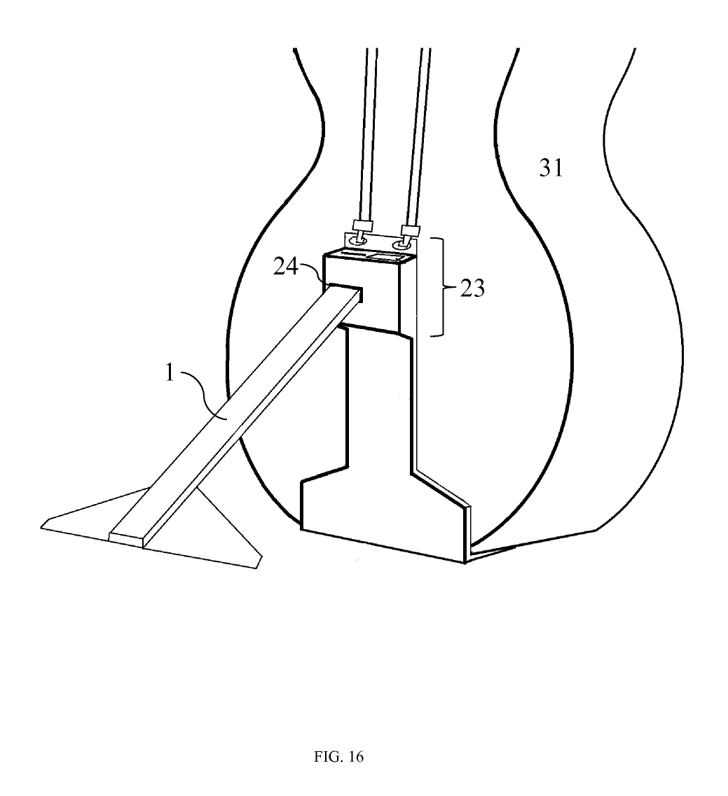

FIG. 16 shows a perspective view wherein the utility support accessory 1 is detachably inserted into the angled slot 24 of the upper connecting portion 23 in a downwardly and outwardly stringed musical instrument 31 supporting position.

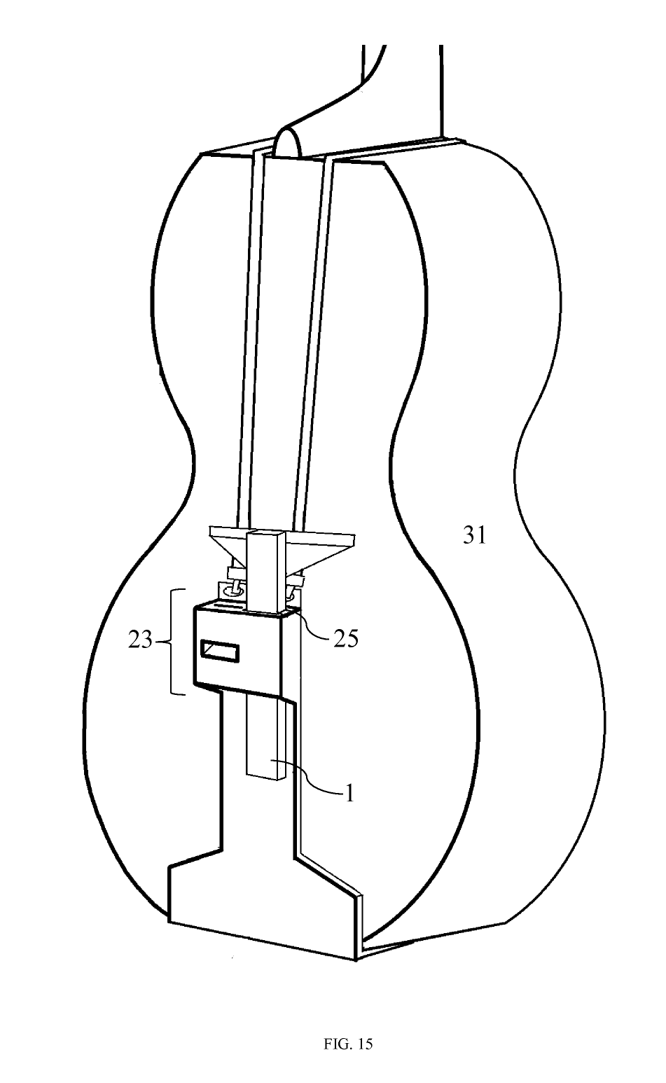

FIG. 15 shows a perspective view illustrating the utility support accessory 1 inserted into the generally parallel slot 25 of the upper connecting portion 23 in an adjacent and generally parallel to the stringed musical instrument 31 storage position.

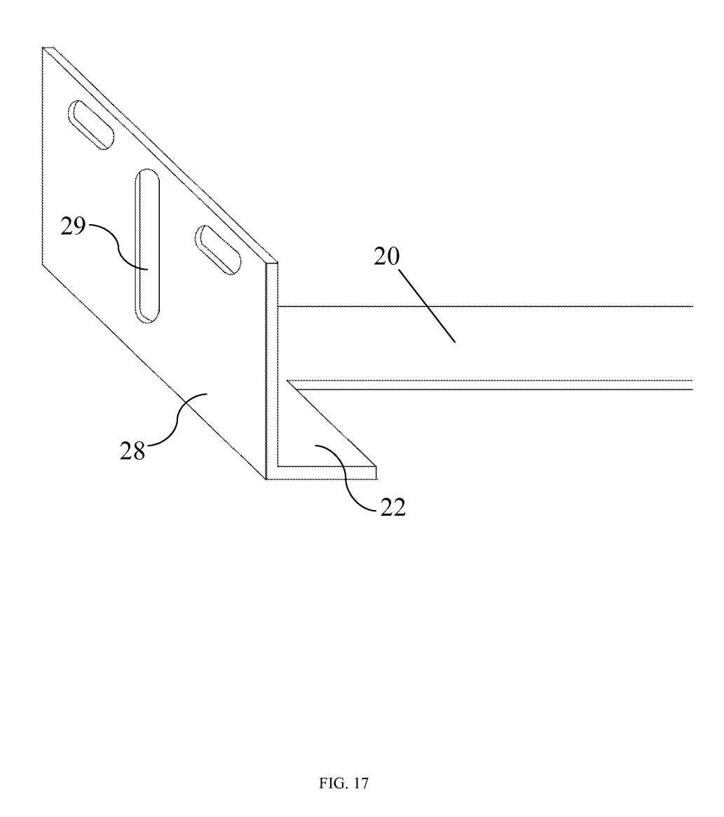

FIG. 17 shows a perspective view of a variation of the lower stabilizing portion 22 of the back piece 20. This variation may be used in conjunction with the plurality of hooked elastic tie downs 19 or it may remove the need for the plurality of hooked elastic tie downs 19 with this alternative embodiment. In this variation the lower stabilizing portion 22 further comprises a generally flat area 28 with an elongated hole 29.

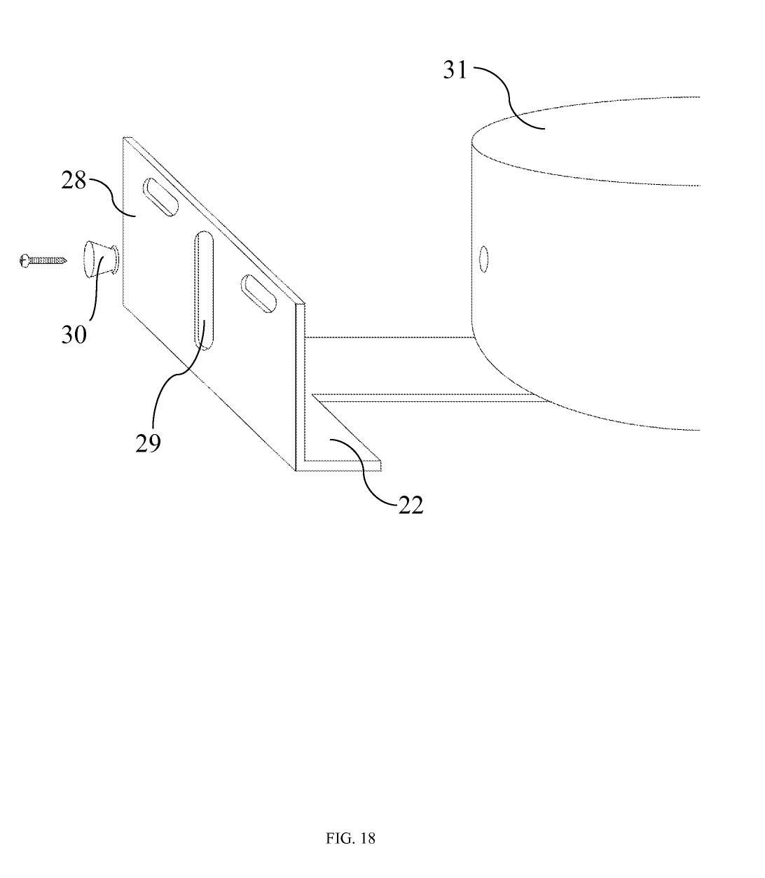

FIG. 18 shows a perspective view of a variation of the lower stabilizing portion 22 of the back piece 20. In this variation the lower stabilizing portion 22 further comprises a generally flat area 28 with an elongated hole 29. The generally flat area 28 with an elongated hole 29 is disposed between the strap pin 30 of the stringed musical instrument 31 and the stringed musical instrument 31.

1. A detachable utility support for a stringed musical instrument and its accessories comprising:
a utility support accessory having a first end, a flared second end and an at least one fastening means;
a connector having an angled slot and a generally parallel slot; and
a stabilizer; wherein
the first end of the utility support accessory is detachably inserted into the angled slot of the connector in a downwardly and outwardly stringed musical instrument supporting position;
the first end of the utility support accessory is detachably inserted into the generally parallel slot of the connector in an adjacent and generally parallel to the stringed musical instrument storage position;
the connector is fastened to the back of the stringed musical instrument with adhesive tape;
the stabilizer is fastened along the bottom rear edge of the stringed musical instrument with adhesive tape; and
the at least one fastening means of the utility support accessory integrate the accessories of the stringed musical instrument with the utility support accessory.

2. The detachable utility support of claim 1, wherein the at least one fastening means of the utility support accessory comprise hook-and-loop fastening material, rubber bands and restickable strips.

3. The detachable utility support of claim 1, wherein the flared second end of the utility support accessory further comprises a rubber grip.

4. The detachable utility support of claim 1, wherein the connector further comprises a third slot capable of receiving at least one pick.

5. The detachable utility support of claim 1, wherein the utility support accessory further comprises a notch with a size and thickness sufficient to fit under a string peg.

6. The detachable utility support of claim 1, wherein the utility support accessory further comprises:
a mechanically integrated tuner;
a capo jaw having a rubber string engaging pad or strip;
a graspable arm;
a pivot; and
a torsion spring wherein,
the pivot couples the capo jaw to the utility support accessory whereby the capo jaw and the utility support accessory are rotatably movable with respect to each other between a neck-clamping closed position and an open position;
the graspable arm is connected to the capo jaw whereby a squeezing action applied thereto will cause the capo jaw and the utility support accessory to move from the neck-clamping closed position toward the open position;
the torsion spring is coupled directly or indirectly to the capo jaw and the utility support accessory such that it exerts a closing force that acts on the capo jaw and the utility support accessory.

7. A detachable utility support for a stringed musical instrument and its accessories comprising:
a utility support accessory having a first end, a flared second end and an at least one fastening means;
a plurality of hooked elastic tie downs; and
a back piece having a plurality of apertures disposed around its edges, a lower stabilizing portion and an upper connecting portion having an angled slot and a generally parallel slot; wherein
the first end of the utility support accessory is detachably inserted into the angled slot of the upper connecting portion in a downwardly and outwardly stringed musical instrument supporting position;
the first end of the utility support accessory is detachably inserted into the generally parallel slot of the upper connecting portion in an adjacent and generally parallel to the stringed musical instrument storage position;
the plurality of apertures of the back piece link to the sound hole of the stringed musical instrument with the plurality of hooked elastic tie downs; and
the at least one fastening means of the utility support accessory integrate the accessories of the stringed musical instrument with the utility support accessory.

8. The detachable utility support of claim 7, wherein the at least one fastening means of the utility support accessory comprise hook-and-loop fastening material, rubber bands and restickable strips.

9. The detachable utility support of claim 7, wherein the flared second end of the utility support accessory further comprises a rubber grip.

10. The detachable utility support of claim 7, wherein the back piece further comprises a third slot capable of receiving at least one pick.

11. The detachable utility support of claim 7, wherein the utility support accessory further comprises a notch with a size and thickness sufficient to fit under a string peg.

12. The detachable utility support of claim 7, wherein the utility support accessory further comprises:
a mechanically integrated tuner;
a capo jaw having a rubber string engaging pad or strip;
a graspable arm;
a pivot; and
a torsion spring wherein,
the pivot couples the capo jaw to the utility support accessory whereby the capo jaw and the utility support accessory are rotatably movable with respect to each other between a neck-clamping closed position and an open position;
the graspable arm is connected to the capo jaw whereby a squeezing action applied thereto will cause the capo jaw and the utility support accessory to move from the neck-clamping closed position toward the open position;
the torsion spring is coupled directly or indirectly to the capo jaw and the utility support accessory such that it exerts a closing force that acts on the capo jaw and the utility support accessory.

13. The detachable utility support of claim 7, wherein the back piece further comprises an at least one spacer.

14. The detachable utility support of claim 13, wherein the at least one spacer comprises an elongated rigid member having a pair of opposite ends wherein each of the opposite ends comprise a channel.

15. The detachable utility support of claim 13, wherein the at least one spacer is disposed between at least two of the plurality of hooked elastic tie downs such that it influences the course of the plurality of hooked elastic tie downs.

16. The detachable utility support of claim 7, wherein the back piece further comprises a connecting link.

17. The detachable utility support of claim 16, wherein the connecting link is disposed in or around the area of the sound hole of the stringed musical instrument

18. The detachable utility support of claim 17, wherein the plurality of hooked elastic tie downs link the back piece to the connecting link.

19. The detachable utility support of claim 7, wherein the lower stabilizing portion of the back piece further comprises a generally flat area with an elongated hole.

20. The detachable utility support of claim 19, wherein the generally flat area with an elongated hole is disposed between the stringed musical instrument and the strap pin of the stringed musical instrument.
